(19) United States
(12) Patent Application Publication
(10) Pub. No.: US 2014/0108949 A1
(43) Pub. Date: Apr. 17, 2014

(54) METHOD AND APPARATUS FOR PROVIDING A REAL-TIME CUSTOMIZED LAYOUT

(71) Applicant: SONY CORPORATION, Tokyo (JP)

(72) Inventor: Sivakumar MURUGESAN, San Diego, CA (US)

(73) Assignee: SONY CORPORATION, Tokyo (JP)

(21) Appl. No.: 13/652,687

(22) Filed: Oct. 16, 2012

(51) Int. Cl. G06F 3/01

(52) U.S. Cl. 715/744

(57) ABSTRACT

Certain aspects of an apparatus and method for providing a real-time, customized layout may include a host that is communicably coupled to a remote device. The host may be operable to communicate a customized layout stored at the host for display on the remote device. The customized layout may enable a user to control one or more functionalities of the host. Further, the host may receive a user input selected from the customized layout that may be communicated by the remote device. The user input may be decoded to generate an output signal that may control one or more functionalities of the host.

### CROSS-REFERENCE TO RELATED APPLICATIONS/INCORPORATION BY REFERENCE

This application makes reference to U.S. Provisional Patent Application Ser. No. 61/621,658 filed on Apr. 9, 2012; and to U.S. patent application Ser. No. 13/605,079 filed on Sep. 6, 2012, which are hereby incorporated herein by reference in their entirety.

### FIELD

Various embodiments of the disclosure relate to electronic devices. More specifically, various embodiments of the disclosure relate to a method and apparatus for providing a real-time, customized layout for controlling one or more functionalities of the electronic devices.

### BACKGROUND

A plurality of appliances with various functionalities may be controlled with multiple remote controllers. For example, a remote controller that may be used for controlling a television may be different from a remote controller that may be used for controlling a DVD player. Accordingly, controlling different appliances with different remote controllers may cause inconvenience to a user using these multiple remote controllers. Moreover, the remote controllers may have too many buttons that may not be of much use to the user in some instances. For example, a user watching a live baseball game on the Television may find a forward button on a remote controller of not much use. Accordingly, there is a need for a universal remote controller for controlling multiple appliances.

Further limitations and disadvantages of conventional and traditional approaches will become apparent to one of skill in the art, through comparison of such systems with some aspects of the present disclosure as set forth in the remainder of the present application with reference to the drawings.

### SUMMARY

An apparatus and/or method is provided for providing a real-time, customized layout substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a network environment for providing a real-time, customized layout for controlling host devices, in accordance with an embodiment of the disclosure.

FIG. 2 is a block diagram of a remote device, in accordance with an embodiment of the disclosure.

FIG. 3 is a block diagram of a host, in accordance with an embodiment of the disclosure.

FIG. 4 is an exemplary customized layout presented on a remote device, in accordance with an embodiment of the disclosure.

FIG. 5 is another exemplary customized layout presented on a remote device, in accordance with an embodiment of the disclosure.

FIG. 6 is another exemplary customized layout presented on a remote device, in accordance with an embodiment of the disclosure.

FIG. 7 is an exemplary multi-layered customized layout displayed on a remote device, in accordance with an embodiment of the disclosure.

FIG. 8 is a flow chart illustrating exemplary steps for providing a real-time, customized layout at a host, in accordance with an embodiment of the disclosure.

FIG. 9 is another flow chart illustrating exemplary steps for providing a real-time, customized layout at a host, in accordance with an embodiment of the disclosure.

### DETAILED DESCRIPTION

Certain implementations may be found in an apparatus and/or method providing a real-time, customized layout. Exemplary aspects of the disclosure may comprise a host communicably coupled to a remote device. In an embodiment, the host may receive a discovery signal from the remote device. In response to the received discovery signal, the host may automatically communicate a customized layout stored at the host for display at the remote device. The customized layout may enable a user to control one or more functionalities of the host. The host may receive user input selected from the customized layout that may be communicated by the remote device. The received user input may be decoded to generate an output signal for controlling the one or more functionalities of the host.

In an embodiment, the host may update the customized layout based on a current state of the host. Additionally, the host may communicate a multi-layered customized layout comprising two or more layers of two or more of the customized layouts to the remote device. In another embodiment, the host may control one or more input devices associated with the remote device for receiving the user input.

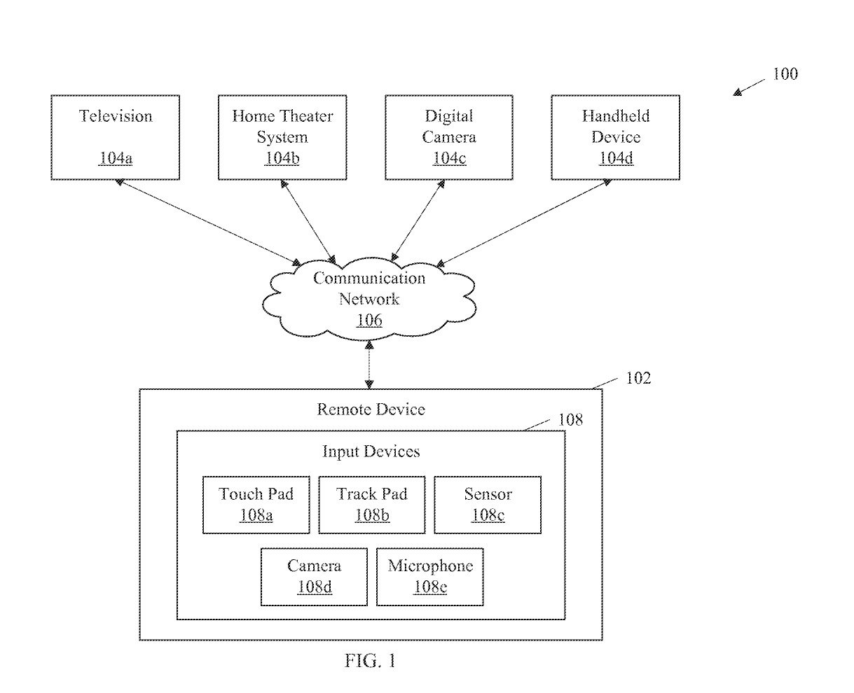

FIG. 1 is a block diagram illustrating a network environment for providing a real-time, customized layout for controlling host devices, in accordance with an embodiment of the disclosure. Referring to FIG. 1, there is shown a network environment 100. The network environment 100 may include a remote device 102, one or more hosts, such as, a television 104a, a home theater system 104b, a digital camera 104c, and a handheld device 104d, and a communication network 106. The one or more hosts may be collectively referred to as “host 104”. Notwithstanding, the disclosure may not be so limited, and other hosts may be utilized without limiting the scope of the disclosure. The remote device 102 may include input devices 108. The input devices 108 may comprise a touch pad 108a, a track pad 108b, a sensor 108c, a camera 108d, and a microphone 108e. Notwithstanding, the disclosure may not be so limited, and many other input devices may be utilized without limiting the scope of the disclosure.

The remote device 102 may comprise suitable logic, circuitry, interfaces, and/or code that may enable communication with the host 104 directly, or via the communication network 106. In an embodiment, the remote device 102 may be capable of transmitting and/or receiving instructions and commands to the host 104. The input devices 108 may be communicably connected to the remote device 102.

The communication network 106 may include a medium through which the remote device 102 and the host 104 in the network environment 100 may communicate with each other. The communication network 106 may be enabled by one or more communication protocols which include, but are not limited to, Wireless Fidelity (Wi-Fi), Wireless Universal Serial Bus (WUSB), Local Area Network (LAN), ZigBee, TCP/IP, Ethernet, and/or Bluetooth communication protocols. Various components in the network environment 100 may connect to the communication network 106, in accordance with various wired and wireless communication protocols, such as, Transmission Control Protocol and Internet Protocol (TCP/IP), User Datagram Protocol (UDP), ZigBee, Infrared (IR), IEEE 802.11a, IEEE 802.11b, IEE 802.11 g, and/or IEEE 802.11n communication protocols. In an embodiment, the remote device 102 and the host 104 may not necessarily use the same communication protocol to communicate with each other. For example, the host 104 may communicate with the remote device 102 using Wi-Fi, whereas the remote device 102 may communicate with the host 104 using Bluetooth.

The input devices 108 may comprise suitable logic, circuitry, interfaces, and/or code that may enable communication with the remote device 102. In an embodiment, several touch-enabled Light Emitting Diodes (LED) may comprise the touch pad 108a. In another embodiment, the touch pad 108a may be a touch-enabled Liquid Crystal Display (LCD) screen. Notwithstanding, the disclosure may not be so limited, and other touch-enabled technologies may be utilized without limiting the scope of the disclosure.

In operation, the remote device 102 and the host 104 may be switched on and the communication network 106 may be activated (for example, Wi-Fi, Bluetooth, and/or the like, may be activated) on the remote device 102 and the host 104. The remote device 102 and the host 104 may be operable to broadcast discovery signals, such as beacon signals, in order to discover each other. Once the remote device 102 and the host 104 discover each other, the host 104 may be operable to automatically communicate an identification (ID) code of the host 104 that may be stored at the remote device 102. The ID code may correspond to a unique serial number or alphanumeric characters that may be used to identify the host 104. Further, the host 104 may automatically communicate a customized layout stored at the host 104 for display at the remote device 102 along with the ID code. The communication of the customized layout to the remote device 102 may occur in response to the reception of the discovery signal broadcast by the remote device 102. The customized layout may include one or more control options specific to a current state of the host 104. The customized layout may enable a user operating the remote device 102 to control one or more functionalities of the host 104 in real-time. The user may select the one or more control options displayed on the touch pad 108a to provide a user input. The remote device 102 may communicate the user input to the host 104. The received user input may be decoded to generate a corresponding output signal that controls the one or more functionalities of the host 104. Examples of the one or more functionalities may include, but are not limited to, volume settings, channel settings, display settings, and/or device settings.

In an embodiment, the host 104 may be operable to update the customized layout based on the current state of the host 104. The current state of the host 104 may correspond to one or more applications running on the host 104. Examples of the one or more applications may include, but are not limited to, a direct television (DTV), a video game, a motion picture, and/or a video chat. In another embodiment, the host 104 may be operable to re-communicate the customized layout after a particular time period. For example, a state of the host 104 at time T1 may be same as that in time T2, where time T1 may be greater than time T2. In such a case, the remote device 102 may have switched to sleep mode in order to save power. Therefore, the host 104 may re-communicate the customized layout communicated at time T1 once again at time T2, in order to refresh the customized layout presented at the remote device 102.

Referring to FIG. 1, the host 104 may correspond to one or more of a Television, a digital video disk player, a digital video recorder, a personal video recorder, a set-top-box, a home theater system, a computer, a digital camera, and/or a smartphone.

In an embodiment, the touch pad 108a may be used to receive touch inputs. The track pad 108b may be used to receive mouse inputs. The sensor 108c (a 3D sensor, for example) may be used to receive an input according to the position of the remote device 102 in space. The camera 108d may be used to receive hand gesture inputs. The microphone 108e may be used to receive voice inputs.

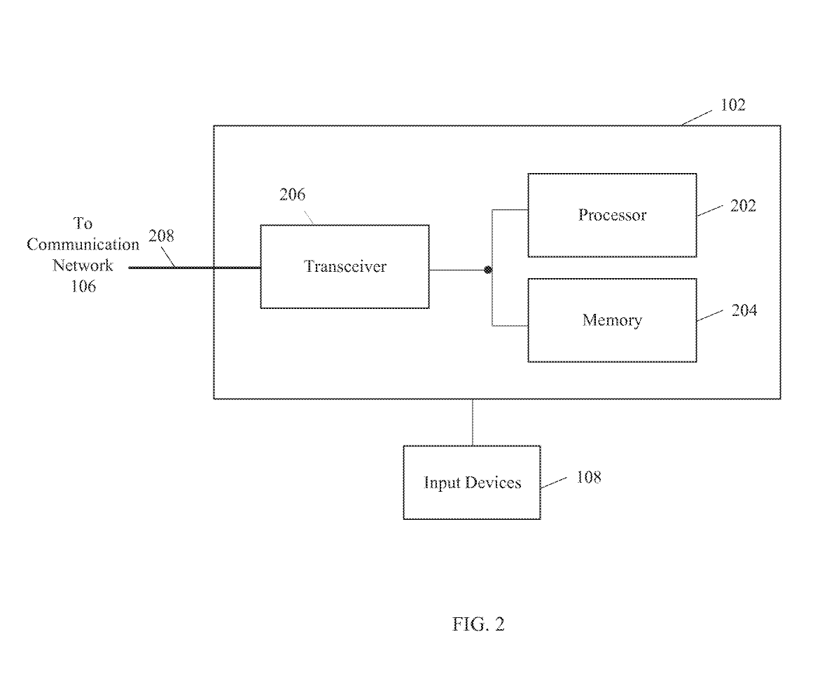

FIG. 2 is a block diagram of a remote device, in accordance with an embodiment of the disclosure. FIG. 2 is explained in conjunction with elements from FIG. 1. Referring to FIG. 2, there is shown the remote device 102. The remote device 102 may comprise a processor 202, a memory 204, a transceiver 206, a communication interface 208, and the input devices 108.

The processor 202 may be communicatively coupled to the memory 204, the transceiver 206, and the input devices 108. The transceiver 206, via the communication interface 208, may be communicatively coupled to the communication network 106.

The processor 202 may comprise suitable logic, circuitry, interfaces, and/or code that may be operable to execute a set of instructions stored in the memory 204. The processor 202 may be implemented based on one or more processor technologies known in the art. Examples of the processor 202 may be an X86-based processor, a RISC processor, an ASIC processor, a CISC processor, or any other processor.

The memory 204 may comprise suitable logic, circuitry, interfaces, and/or code that may be operable to store the received set of instructions. The memory 204 may be implemented based on, but not limited to, a Random Access Memory (RAM), a Read-Only Memory (ROM), a Hard Disk Drive (HDD), a storage server, and/or a secure digital (SD) card.

The transceiver 206 may comprise suitable logic, circuitry, interfaces, and/or code that may be operable to communicate with the host 104, via the communication interface 208. In an embodiment, the transceiver 206 may be operable to communicate with the host 104. The transceiver 206 may implement known technologies for supporting wired or wireless communication with the communication network 106.

The input devices 108 may comprise suitable logic, circuitry, interfaces, and/or code that may be operably coupled to the processor 202 to receive a user input. Examples of the input devices 108 may include, but are not limited to, the touch pad 108a, the track pad 108b, the sensor 108c, the camera 108d, and/or the microphone 108e.

In operation, the transceiver 206 may be operable to broadcast the discovery signal by utilizing one or more of Wi-Fi, Bluetooth, Infrared (IR), and/or ZigBee communication protocols. Upon receipt of the discovery signal at the host 104, the host 104 may be operable to communicate the ID code of the host 104 and the customized layout to the remote device 102. The processor 202 may be operable to receive the ID code and the customized layout. The processor 202 may be operable to store the communicated ID code at the memory 204 to facilitate communication with the host 104. Further, the processor 202 may be operable to present the customized layout comprising one or more control options for display at the touch pad 108a. The user operating the remote device 102 may provide one or more user inputs by touching the one or more control options on the touch pad 108a. The processor 202 may communicate the one or more user inputs to the host 104. Based on the one or more user inputs, the one or more functionalities of the host 104 may be controlled.

In an embodiment, the input devices 108 may be controlled by the host 104 whenever a user input may be required via the input devices 108. In another embodiment, the processor 202 may be operable to sense a pattern drawn on the touch pad 108a as the user input. For example, an “S” or a circle drawn on the touch pad 108a may correspond to one or more control options that may control the one or more functionalities of the host 104. Further, the processor 202 may communicate the user input to the host 104.

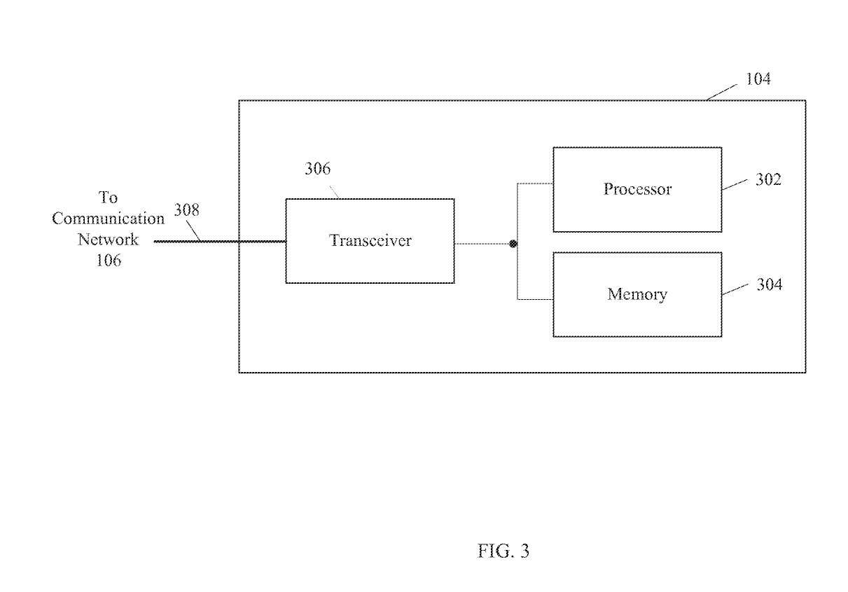

FIG. 3 is a block diagram of a host, in accordance with an embodiment of the disclosure. FIG. 3 is explained in conjunction with elements from FIG. 1 and FIG. 2. Referring to FIG. 3, there is shown the host 104. The host 104 may comprise a processor 302, a memory 304, a transceiver 306, and a communication interface 308.

The processor 302 may be communicatively coupled to the memory 304, and the transceiver 306. The transceiver 306, via the communication interface 308, may be communicatively coupled to the communication network 106.

The processor 302 may comprise suitable logic, circuitry, interfaces, and/or code that may be operable to execute a set of instructions stored in the memory 304. The processor 302 may be implemented based on one or more processor technologies known in the art. Examples of the processor 302 may be an X86-based processor, a RISC processor, an ASIC processor, a CISC processor, or any other processor.

The memory 304 may comprise suitable logic, circuitry, interfaces, and/or code that may be operable to store the received set of instructions. The memory 304 may be implemented based on, but not limited to, a Random Access Memory (RAM), a Read-Only Memory (ROM), a Hard Disk Drive (HDD), a storage server, and/or a secure digital (SD) card.

The transceiver 306 may comprise suitable logic, circuitry, interfaces, and/or code that may be operable to communicate with the remote device 102, via the communication interface 308. In an embodiment, the transceiver 306 may be operable to communicate with the remote device 102. The transceiver 306 may implement known technologies for supporting wired or wireless communication with the communication network 106.

In operation, the processor 302 may be operable to receive the discovery signal broadcast by the remote device 102. Upon receipt of the discovery signal, the processor 302 may automatically communicate the ID code of the host 104 to the remote device 102. The remote device 102 may store the received ID code to facilitate communication with the host 104. Further, the processor 302 may automatically communicate the customized layout corresponding to the current state of the host 104 to the remote device 102. The remote device 102 may present one or more control options associated with the customized layout without storing the customized layout. The user operating the remote device 102 may provide one or more inputs by using the one or more control options. The remote device 102 may communicate the one or more user inputs to the host 104. The processor 302 may decode the communicated one or more user inputs to generate one or more output signals that may control the one or more functionalities of the host 104. Examples of the one or more functionalities may include, but are not limited to, the volume settings, the channel settings, the display settings, and/or the device settings.

In an embodiment, the processor 302 may enable one or more input devices (such as the input devices 108) associated with the remote device 102 to receive the one or more user inputs. For example, the host 104 may require a voice input from the user. In such a case, the host 104 may communicate instructions to the processor 202 for enabling the microphone 108e associated with the remote device 102. The processor 202 may enable the microphone 108e of the remote device 102 to receive a voice input for controlling the one or more functionalities of the host 104. Further, the processor 202 may be operable to present an icon indicating the enablement of the microphone 108e on the touch pad 108a. The icon may indicate the requirement of voice input from the user.

In an embodiment, the customized layout may be in one or more formats such as, but not limited to, an extensible markup language (XML), a hypertext markup language (HTML), a hypertext transport protocol (HTTP), and/or any other format.

Further, communication between host 104 and the remote device 102 may be via one or more of Wi-Fi, Bluetooth, Infrared (IR), and/or ZigBee communication protocols based on an available bandwidth for communication.

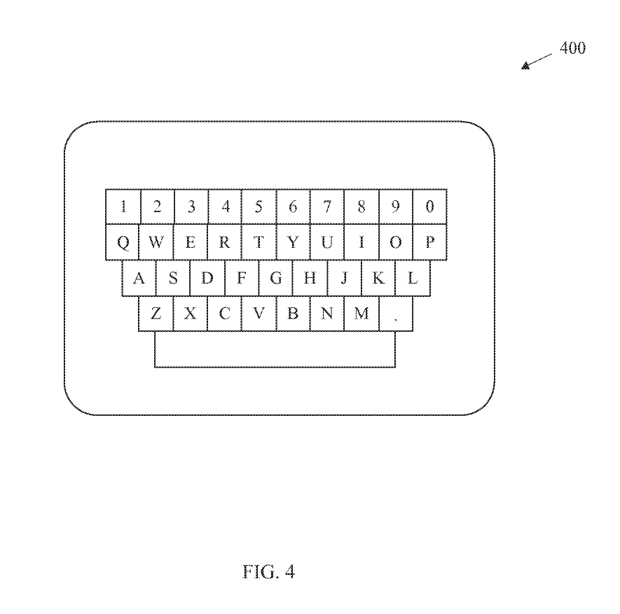

FIG. 4 is an exemplary customized layout presented on a remote device, in accordance with an embodiment of the disclosure. Further, FIG. 4 is explained in conjunction with FIG. 1, FIG. 2, and FIG. 3. Referring to FIG. 4, there is shown a customized layout 400 associated with the remote device 102. In an embodiment, an application (a text chat, for example) may be running on the host 104 (a smart TV, for example). In such a case, the host 104 may communicate the customized layout 400 for display at the remote device 102. The customized layout 400 may comprise a QWERTY keypad along with number keys. A user operating the remote device 102 may utilize the QWERTY keypad and/or the number keys to provide a user input to control the host 104.

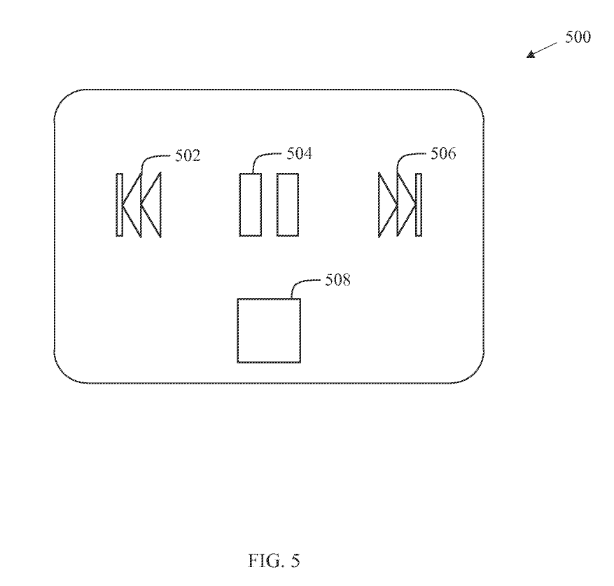

FIG. 5 is an exemplary customized layout presented on a remote device, in accordance with an embodiment of the disclosure. Further, FIG. 5 is explained in conjunction with FIG. 1, FIG. 2, and FIG. 3. Referring to FIG. 5, there is shown a customized layout 500 associated with the remote device 102. The customized layout 500 may be communicated by the host 104 (a BD-ROM player, for example). The customized layout 500 may be presented on the remote device 102. In an embodiment, when a movie is being displayed on the TV, the BD-ROM player may communicate the customized layout 500 that may have the one or more control options, such as a rewind button 502, a pause button 504, a forward button 506, and a stop button 508 for display at the touch pad 108a. One or more control options, such as a play button, may not be presented on the touch pad 108a when the movie is being displayed. Since the current state of the BD-ROM player does not require the play button (essentially because the movie is already being played), the BD-ROM player does not present the play button on the touch pad 108a.

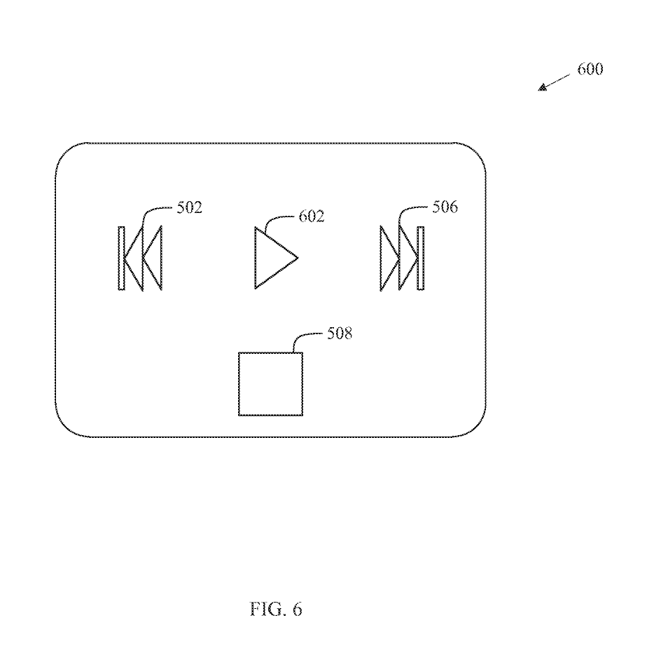

FIG. 6 is another exemplary customized layout presented on a remote device, in accordance with an embodiment of the disclosure. Further, FIG. 6 is explained in conjunction with FIG. 1, FIG. 2, FIG. 3, and FIG. 5. Referring to FIG. 6, there is shown a customized layout 600 associated with the remote device 102. The customized layout 600 may be communicated by the BD-ROM player that may be presented on the remote device 102. In an embodiment, when the movie is paused, the host 104 (the BD-ROM player, for example) may communicate the customized layout 600 that may have one or more control options, such as the rewind button 502, the forward button 506, the stop button 508, and a play button 602 for display at the touch pad 108a. One or more control options, such as the pause button 504 may not be presented on the touch pad 108a when the movie is paused, essentially because the movie was paused already. Therefore, the customized layout 600 that may be communicated by the host 104 is based on the current state of the host 104.

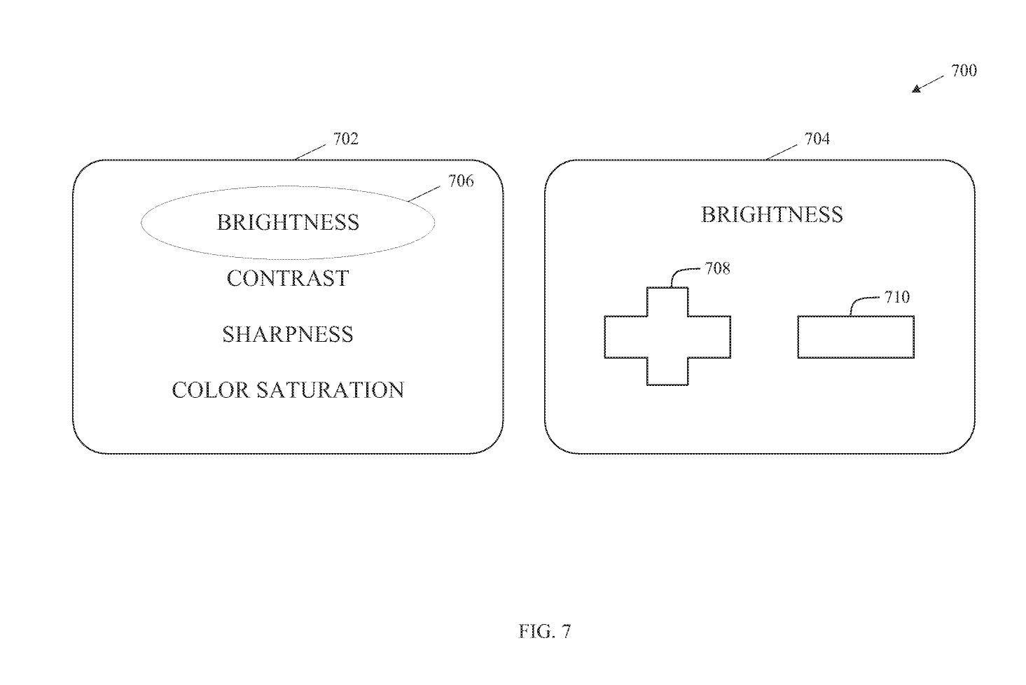

In an embodiment, the processor 302 may be operable to communicate a multi-layered, customized layout comprising two or more layers of two or more of the customized layouts to the remote device 102. The processor 302 may be operable to enable at least one of the two or more layers of the multi-layered, customized layout based on the current state of the host 104. The two or more of the customized layouts may correspond to the one or more functionalities of the host 104. The multilayered, customized layout displayed on the remote device 102 is explained in detail in FIG. 7.

FIG. 7 is an exemplary multi-layered customized layout displayed on a remote device, in accordance with an embodiment of the disclosure. Referring to FIG. 7 there is shown a multi-layered, customized layout 700 comprising a first layer 702 and a second layer 704.

In an embodiment, the first layer 702 may include one or more control options such as, brightness, contrast, sharpness, and/or color saturation pertaining to an application (a motion picture, for example) running on the host 104 (a smart TV, for example). A user operating the remote device 102 may provide a user input by touching “a brightness control option 706”. Subsequently, the second layer 704 comprising a brightness increase button 708 and a brightness decrease button 710 may be presented on the touch pad 108a. The brightness increase button 708 and the brightness decrease button 710 may be used by the user to control the brightness of a motion picture.

In another embodiment, the application (the motion picture, for example) running on the host 104 (the smart TV, for example) may need a first customized layout for controlling brightness of the motion picture and a second customized layout for controlling sound emitted by one or more speakers of the TV. In such a case, the smart TV may communicate a multi-layered, customized layout comprising two layers, such as a first layer and a second layer. The first layer may comprise a first customized layout pertaining to one or more control options for controlling brightness. The second layer may comprise a second customized layout pertaining to one or more control options for controlling volume. The first layer comprising the first customized layout for controlling brightness may be used by the user to control the brightness of the motion picture while the second layer comprising the second customized layout for controlling volume may be used by the user to control the one or more speakers.

In an embodiment, the touch pad 108a may not have space to present an entire customized layout having all the control options for controlling the host 104. Therefore, the host 104 may communicate a portion of the control options in a first layer and another portion of the control options in a second layer of the multi-layer customized layout.

In an embodiment, the host 104 may enable the two or more layers based on a user input required by the host 104. In an alternate embodiment, the user may provide one or more gesture inputs such as, flipping (like flipping through a page, for example) to navigate between the two or more layers. Notwithstanding, the disclosure may not be so limited, and other gestures may be utilized without limiting the scope of the invention.

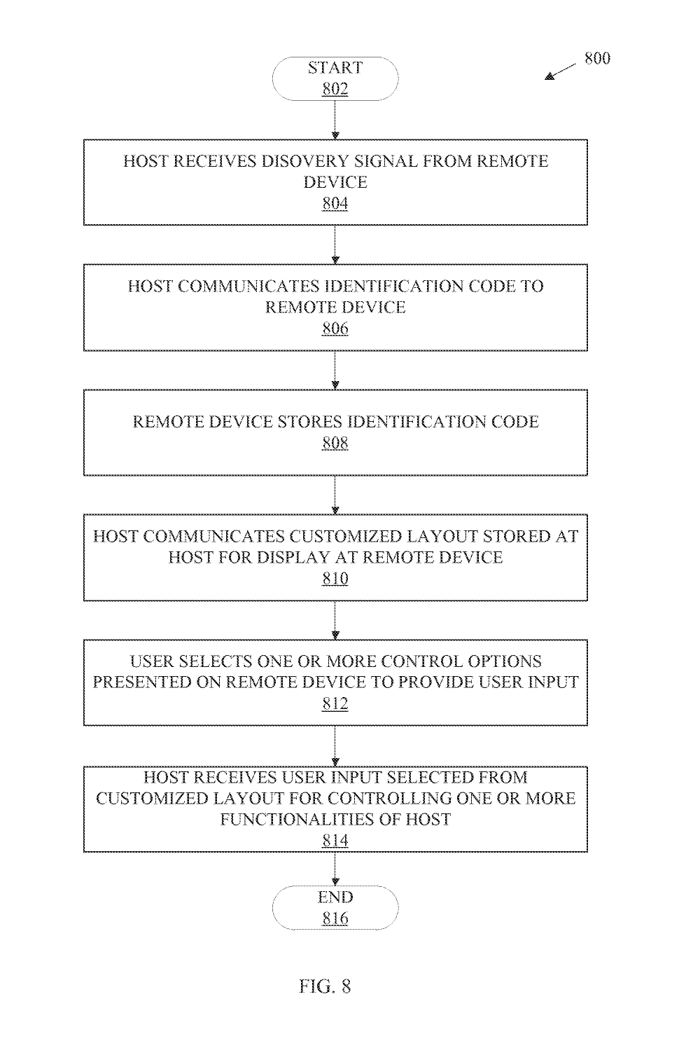

FIG. 8 is a flow chart illustrating exemplary steps for providing a real-time, customized layout at a host, in accordance with an embodiment of the disclosure. Referring to FIG. 8, there is shown a method 800. The method 800 is described in conjunction with the elements of FIG. 1, FIG. 2, and FIG. 3.

Exemplary steps begin at step 802. At step 804, the host 104 may receive the discovery signal from the remote device 102. The processor 302 may receive the discovery signal communicated by the transceiver 206 of the remote device 102. At step 806, the host 104 may communicate the ID code to the remote device 102. Upon receipt of the discovery signal, the processor 302 may communicate the ID code to the remote device 102. At step 808, the remote device 102 may store the ID code. The processor 202 may store the identification code in the memory 204. At step 810, the host 104 may communicate the customized layout stored at the host 104 for display at the remote device 102. The processor 302 may communicate the customized layout stored at the memory 304 of the host 104 for display at the remote device 102. The processor 202 of the remote device 102 may display the customized layout at the touch pad 108a. However, the customized layout may not be stored at the memory 204 of the remote device 102.

At step 812, the user may select one or more control options presented on the remote device 102 to provide user input. The processor 202 may communicate the user input to the host 104. At step 814, the host 104 may receive the user input selected from the customized layout for controlling the one or more functionalities of the host 104. The processor 302 may receive the user input selected from the customized layout for controlling the one or more functionalities of host 104 in real-time. The method 800 ends at step 816.

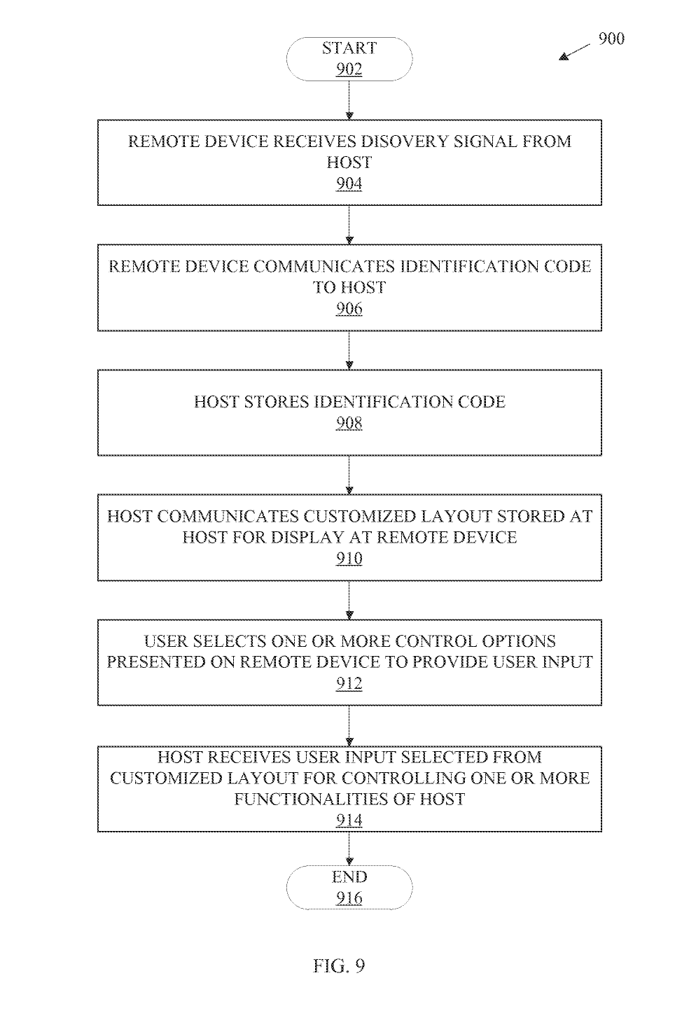

FIG. 9 is another flow chart illustrating exemplary steps for providing a real-time, customized layout at a host, in accordance with an embodiment of the disclosure. Referring to FIG. 9, there is shown a method 900. The method 900 is described in conjunction with the elements of FIG. 1, FIG. 2, and FIG. 3.

Exemplary steps begin at step 902. At step 904, the remote device 102 may receive the discovery signal from the host 104. The processor 202 may receive the discovery signal communicated by the transceiver 306 of the host 104. At step 906, the remote device 102 may communicate an identification code of the remote device 102 to the host 104. Upon receipt of the discovery signal, the processor 202 may communicate the identification code associated with the remote device 102 to the host 104. At step 908, the host 104 may store the ID code. The processor 302 may store the identification code in the memory 304. At step 910, the host 104 may communicate the customized layout stored at the host 104 for display at the remote device 102. The processor 302 may communicate the customized layout stored at the memory 304 of the host 104 for display at the remote device 102. The processor 202 of the remote device 102 may display the customized layout at the touch pad 108a. However, the customized layout may not be stored at the memory 204 of the remote device 102.

At step 912, the user may select one or more control options presented on the touch pad 108a to provide user input. The processor 202 may communicate the user input to the host 104. At step 914, the host 104 may receive the user input selected from the customized layout for controlling the one or more functionalities of the host 104. The processor 302 may receive the user input selected from the customized layout for controlling the one or more functionalities of host 104 in real-time. The method 900 ends at step 916.

In accordance with an embodiment of the disclosure, an apparatus for providing a real-time, customized layout may comprise a host 104 (FIG. 1) that may be communicably coupled to a remote device 102 (FIG. 1). The host 104 may comprise one or more processors and/or circuits, for example, processor 302 (FIG. 3) that may be operable to receive a discovery signal from the remote device 102. The host 104 may communicate the customized layout stored at the host 104 for display at the remote device 102. The customized layout may enable a user to control one or more functionalities of the host 104. Examples of the one or more functionalities may include, but are not limited to, volume settings, channel settings, display settings, and/or device settings. The host 104 may receive a user input selected from the customized layout from the remote device 102. The received user input may be decoded to generate an output signal for controlling the one or more functionalities of the host 104.

In an embodiment, the host 104 may automatically communicate the customized layout in response to the received discovery signal. The host 104 may update the customized layout based on a current state of the host 104. Further, the host 104 may re-communicate the customized layout after a particular time period. The host 104 may communicate with the remote device 102 using one or more of Wi-Fi, Bluetooth, Infrared (IR), and/or ZigBee communication protocols.

In an embodiment, the host 104 may control one or more input devices (such as the input devices 108) associated with the remote device 102 for receiving the user input. Examples of the one or more input devices (such as the input devices 108) may include, but are not limited to, the touch pad 108a, the track pad 108b, the sensor 108c, the camera 108d, and/or the microphone 108e. Additionally, the host 104 may communicate a multi-layered customized layout comprising two or more layers of two or more of the customized layouts to the remote device 102. The two or more of the customized layouts correspond to the one or more functionalities of the host 104. Further, the host 104 may enable at least one of the two or more layers of the multi-layered customized layout based on the current state of the host 104. Examples of the host 104 may include, but are not limited to, a Television, a digital video disk player, a digital video recorder, a personal video recorder, set-top-box, a home theater system, a computer, a digital camera, and/or a smartphone.

In accordance with another embodiment of the disclosure, a method and apparatus for providing a real-time, customized layout may comprise a reconfigurable remote device, for example, remote device 102 (FIG. 1) that is communicably coupled to one or more hosts, for example, host 104 (FIG. 1). The remote device 102 may comprise one or more processors and/or circuits, for example, processor 202 (FIG. 2) that may be operable to receive one or more identification codes associated with the one or more hosts. Further, the one or more processors and/or circuits may receive one or more customized layouts corresponding to the one or more hosts. The received one or more customized layouts are based on a current state of the one or more hosts. The one or more customized layouts may be stored at the one or more hosts. Further the one or more processors and/or circuits may be operable to communicate a user input to the one or more hosts. The user input may be selected from the received one or more customized layouts for controlling one or more functionalities of the one or more hosts.

Other embodiments of the disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps comprising in a host communicably coupled to a remote device communicating a customized layout stored at the host for display on the remote device. The customized layout may enable a user to control one or more functionalities of the host. The steps further comprising, receiving a user input from the remote device. The user input may be selected from the customized layout. The received user input may be decoded to generate an output signal for controlling the one or more functionalities of the host. The customized layout may be automatically communicated in response to the received discovery signal. The customized layout may be updated based on a current state of the host. The one or more input devices associated with the remote device may be controlled for receiving the user input. A multi-layered, customized layout comprising two or more layers of two or more of the customized layouts may be communicated to the remote device. The two or more of the customized layouts correspond to the one or more functionalities of the host.

Accordingly, the present disclosure may be realized in hardware, or a combination of hardware and software. The present disclosure may be realized in a centralized fashion in at least one computer system or in a distributed fashion where different elements may be spread across several interconnected computer systems. Any kind of computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to various embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A host for communication, said host comprising:
one or more processors and/or circuits in said host that is communicably coupled to a remote device, said one or more processors and/or circuits being operable to:
communicate a customized layout stored at said host for display on said remote device, wherein said customized layout enables a user to control one or more functionalities of said host; and
receive a user input from said remote device, wherein said user input is selected from said customized layout.

2. The host of claim 1, wherein said one or more processors and/or circuits are operable to update said customized layout based on a current state of said host.

3. The host of claim 1, wherein said one or more processors and/or circuits are operable to decode said received user input to generate an output signal for controlling said one or more functionalities of said host.

4. The host of claim 1, wherein said one or more processors and/or circuits are operable to receive a discovery signal from said remote device.

5. The host of claim 4, wherein said one or more processors and/or circuits are operable to automatically communicate said customized layout to said remote device in response to said received discovery signal.

6. The host of claim 1, wherein said one or more functionalities comprises one or more of: volume settings, channel settings, display settings, and/or device settings.

7. The host of claim 1, wherein said one or more processors and/or circuits are operable to control one or more input devices associated with said remote device.

8. The host of claim 7, wherein said one or more input devices comprises one or more of: a touch pad, a track pad, a sensor, a camera, and/or a microphone.

9. The host of claim 1, wherein said one or more processors and/or circuits are operable to re-communicate said customized layout after a particular time period.

10. The host of claim 1, wherein said one or more processors and/or circuits are operable to communicate in real-time to said remote device, a multi-layered customized layout comprising two or more layers of two or more of said customized layouts.

11. The host of claim 10, wherein said two or more of said customized layouts correspond to said one or more functionalities of said host.

12. The host of claim 10, wherein said one or more processors and/or circuits are operable to enable in real-time, at least one of said two or more layers of said multi-layered customized layout based on a current state of said host.

13. The host of claim 1, wherein said one or more processors and/or circuits are operable to communicate with said remote device using one or more of: Wireless Fidelity (Wi-Fi), Bluetooth, Infrared (IR), and/or ZigBee communication protocols.

14. The host of claim 1, wherein said host corresponds to one or more of: a Television, a digital video disk player, a digital video recorder, a personal video recorder, a set-top-box, a home theater system, a computer, a digital camera, and/or a smartphone.

15. A method for communication, said method comprising:
in a host communicably coupled to a remote device:
communicating a customized layout stored at said host for display on said remote device, wherein said customized layout enables a user to control one or more functionalities of said host ; and
receiving a user input from said remote device, wherein said user input is selected from said customized layout.

16. The method of claim 15, comprising updating said customized layout based on a current state of said host.

17. The method of claim 15, comprising decoding said received user input to generate an output signal for controlling said one or more functionalities of said host.

18. The method of claim 15, comprising receiving a discovery signal from said remote device.

19. The method of claim 18, comprising automatically communicating said customized layout to said remote device in response to said received discovery signal.

20. The method of claim 15, comprising controlling one or more input devices associated with said remote device.

21. The method of claim 15, comprising communicating in real-time to said remote device, a multi-layered customized layout comprising two or more layers of two or more of said customized layouts.

22. A reconfigurable remote device for communication, said reconfigurable remote device comprising:
one or more processors and/or circuits in said reconfigurable remote device that is communicably coupled to one or more hosts, said one or more processors and/or circuits being operable to:
receive one or more customized layouts corresponding to said one or more hosts, wherein said one or more customized layouts are stored at said one or more hosts; and
communicate a user input to said one or more hosts, wherein said user input is selected from said received one or more customized layouts for controlling one or more functionalities of said one or more hosts.

23. The reconfigurable remote device of claim 22, wherein said one or more processors and/or circuits are operable to receive one or more identification codes associated with said one or more hosts.

24. The reconfigurable remote device of claim 22, wherein said received one or more customized layouts are based on a current state of said one or more hosts.
